(19) United States
(12) Patent Application Publication
(10) Pub. No.: US 2014/0072242 A1
(43) Pub. Date: Mar. 13, 2014

(54) METHOD FOR INCREASING IMAGE RESOLUTION

(71) Applicants: Hao Wei, Pittsford, NY (US); James E. Adams, Rochester, NY (US); Raymond William Ptucha, Honeoye Falls, NY (US); Rodney L. Miller, Fairport, NY (US)

(72) Inventors: Hao Wei, Pittsford, NY (US); James E. Adams, Rochester, NY (US); Raymond William Ptucha, Honeoye Falls, NY (US); Rodney L. Miller, Fairport, NY (US)

(21) Appl. No.: 13/608,099

(22) Filed: Sep. 10, 2012

(51) Int. Cl. G06K 9/32

(52) U.S. Cl. 382/299

(57) ABSTRACT

A method for resizing an input digital image to provide a high-resolution output digital image having a larger number of image pixels. The input image pixels in the input digital image are analyzed and assigned to different pixel classifications. A plurality of pixel generation processes are provided, each pixel generation process being associated with a different pixel classification and being adapted to operate on a neighborhood of input image pixels around a particular input image pixel to provide a plurality of output image pixels. Each input image pixel is processed using a pixel generation process that is selected in accordance with the corresponding pixel classification to produce the high-resolution output digital image.

### CROSS-REFERENCE TO RELATED APPLICATIONS

Reference is made to commonly assigned, co-pending U.S. patent application Ser. No. 13/346,816 (docket K000673), entitled: “Super-resolution using selected edge pixels”, by Adams et al., which is incorporated herein by reference.

### FIELD OF THE INVENTION

This invention pertains to the field of digital image processing and more particularly to a method for increasing the resolution of a digital image.

### BACKGROUND OF THE INVENTION

In order to reduce the image data for storage and transmission, high-resolution images are often being down-sized and then compressed to produce low-resolution images with a smaller file size. The consequence of these degradation processes, both down-sizing and compression, is losing high-frequency information in the original images. However, it is frequently desirable to invert the processes to produce a high-resolution image from a low-resolution image. Both down-sizing and compression are lossy processes, and are not invertible mathematically. Many algorithms have been developed that attempt to approximately invert the two degradation processes separately. Generally, down-sizing operations are performed in spatial domain, while compression operations are performed in frequency domain. It is challenging to develop an algorithm to simultaneously account for both losses.

Commonly used algorithms for increasing the resolution are interpolation and machine learning. The interpolation algorithms are typically based on some assumptions about the characteristics of the original image. The main problem with this approach is that the interpolation operation cannot restore the high-frequency spatial detail discarded by the down-sizing process. Simple interpolation methods such as linear or cubic interpolation tend to generate overly smooth images with ringing and jagged artifacts.

Machine learning algorithms are based on using prior knowledge to estimate the high-frequency details in the high-resolution images. In the article “Example-based super-resolution” (IEEE Computer Graphics and Applications, Vol. 22, pp. 56-65, 2002), Freeman, et al. describe a promising frame work for an example-based super-resolution algorithm. A set of basis functions form a dictionary from which any new image region can be constructed as a sparse linear combination of elements in the dictionary. Matched low- and high-resolution dictionaries are created during a training phase. The coefficients necessary to recreate a low-resolution image region are applied to the high resolution dictionary forming a high resolution test image region. The problem with this approach is that the dictionary needs to be large to produce smooth and graceful coefficient activity across diverse test imagery. If the dictionary has too few entries, there may not be enough variety in the spatial information to produce a good quality high-resolution image. The solution of having a large dictionary, however, brings with it storage issues and the increased compute power necessary to solve for coefficients from so many dictionary elements.

JPEG is a commonly used compression algorithm for digital images. The JPEG compression process partitions an image into 8×8 pixel blocks, applying discrete cosine transform (DCT) to each block to obtain an 8×8 DCT coefficient array F[u,v], where u and v are numbers between 1 and 8. The DCT coefficients are quantized by an 8×8 array of numbers called quantization table Q[u,v]. Quantized DCT coefficients F′[u,v] are determined according to the following equation:

F′[u,v]=round(F[u,v]/Q[u,v]) (1)

The luminance quantization table recommended by the JPEG standard (table T50) is shown in Eq. (2). The numbers in the table can be scaled up (or down) to increase (or decrease) the degree of compression at each individual frequency.

$$T 50 [ u , v ] = ( \begin{matrix}16 & 11 & 10 & 16 & 24 & 40 & 51 & 61 \\ 12 & 12 & 14 & 19 & 26 & 58 & 60 & 55 \\ 14 & 13 & 16 & 24 & 40 & 57 & 69 & 56 \\ 14 & 17 & 22 & 29 & 51 & 87 & 80 & 62 \\ 18 & 22 & 37 & 56 & 68 & 109 & 103 & 77 \\ 24 & 35 & 55 & 64 & 81 & 104 & 113 & 92 \\ 49 & 64 & 78 & 87 & 103 & 121 & 120 & 101 \\ 72 & 92 & 95 & 98 & 112 & 100 & 103 & 99\end{matrix} ) \qquad ( 2 )$$

It is well known to those skilled in the art that the human vision system is generally more sensitive to lower frequencies (upper left corner of the array), and is generally less sensitive to higher frequencies (lower right corner of the array). Therefore, it is common that the quantization table has smaller numbers in upper left corner and larger numbers in the lower right corner. With this kind of quantization table the compression is archived by removing the small high-frequency component in DCT coefficients. However, when the image is up-scaled, the missing high-frequency information is shifted to lower frequencies, and the up-scaled image can therefore exhibit visible JPEG compression artifacts. Over the years, many artifact removal algorithms have been developed. Most of them concentrate on block artifacts that result from a high degree of compression. Commonly assigned U.S. Pat. No. 7,139,437 to Jones et al., entitled “Method and system for removing artifacts in compressed images,” is an example of one such method.

There remains a need for a fast and robust technique to simultaneously increase the resolution of a digital image and perform JPEG compression artifact removal.

### SUMMARY OF THE INVENTION

The present invention represents a method for processing an input digital image having a number of input image pixels to determine an output digital image having a larger number of output image pixels, comprising:

analyzing the image pixels in the input digital image to assign each image pixel to one of a plurality of different pixel classifications;

providing a plurality of pixel generation processes, each pixel generation process being associated with a different pixel classification and being adapted to operate on a neighborhood of input image pixels around a particular input image pixel to provide a plurality of output image pixels corresponding to the particular input image pixel;

for each input image pixel:
selecting the pixel generation process corresponding to the pixel classification associated with the input image pixel; and
operating on a neighborhood of input image pixels around the input image pixel using the selected pixel generation process to provide a plurality of output image pixels for the output digital image; and

storing the output digital image in a processor accessible memory; wherein the method being performed, at least in part, by a data processor.

This invention has the advantage that both the increase of image resolution and the removal of JPEG artifacts, or other image artifacts such as noise/grain, are addressed at same time. It produces improved and more consistent results, especially in dealing with visible artifacts after image resolution is increased.

This invention has the additional advantage that since the processing models are generated based on a prior knowledge of image resizing and JPEG compression, the method is able to recover some missing information lost in the degradation process. As a result, the method can produce an enhanced image that is closer to an original high-resolution image.

Since the invention is based on a neural network framework, it has the additional advantage that it requires substantially less computation resources and processing time than many prior art methods.

### BRIEF DESCRIPTION OF THE DRAWINGS

FIG. 1 is a high-level diagram showing the components of an image processing system according to an embodiment of the present invention;

FIG. 2 is a block diagram illustrating a process for generating an improved high-resolution digital image according to an embodiment of present invention;

FIG. 3 is a block diagram showing additional details of the pixel generation process selection block in FIG. 2;

FIGS. 4A and 4B are block diagrams showing additional details for exemplary embodiments of the assign pixel classifications block in FIG. 3;

FIG. 5 is a schematic diagram illustrating the generation of high-resolution image pixels using a pixel generation process according to an embodiment of the present invention;

FIG. 6 is a block diagram of an exemplary neural network training process; and

FIG. 7 is a schematic diagram illustrating the generation of high-resolution image pixels using of a pixel generation process according to an alternate embodiment of the present invention; and

FIG. 8 is a block diagram showing additional details of the post processing block 270 of FIG. 2 according to an embodiment of the present invention.

It is to be understood that the attached drawings are for purposes of illustrating the concepts of the invention and may not be to scale.

### DETAILED DESCRIPTION OF THE INVENTION

In the following description, some embodiments of the present invention will be described in terms that would ordinarily be implemented as software programs. Those skilled in the art will readily recognize that the equivalent of such software may also be constructed in hardware. Because image manipulation algorithms and systems are well known, the present description will be directed in particular to algorithms and systems forming part of, or cooperating more directly with, the method in accordance with the present invention. Other aspects of such algorithms and systems, together with hardware and software for producing and otherwise processing the image signals involved therewith, not specifically shown or described herein may be selected from such systems, algorithms, components, and elements known in the art. Given the system as described according to the invention in the following, software not specifically shown, suggested, or described herein that is useful for implementation of the invention is conventional and within the ordinary skill in such arts.

The invention is inclusive of combinations of the embodiments described herein. References to “a particular embodiment” and the like refer to features that are present in at least one embodiment of the invention. Separate references to “an embodiment” or “particular embodiments” or the like do not necessarily refer to the same embodiment or embodiments; however, such embodiments are not mutually exclusive, unless so indicated or as are readily apparent to one of skill in the art. The use of singular or plural in referring to the “method” or “methods” and the like is not limiting. It should be noted that, unless otherwise explicitly noted or required by context, the word “or” is used in this disclosure in a non-exclusive sense.

The phrase, “digital image file”, as used herein, refers to any digital image file, such as a digital still image or a digital video file.

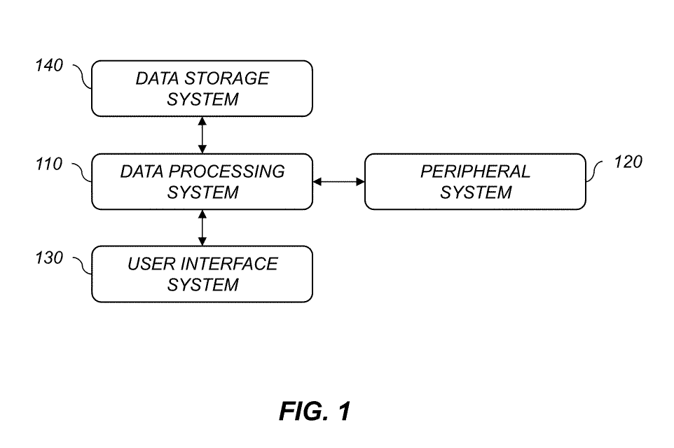

FIG. 1 is a high-level diagram showing the components of an image processing system useful for embodiments of the present invention. The system includes a data processing system 110, a peripheral system 120, a user interface system 130, and a data storage system 140. The peripheral system 120, the user interface system 130 and the data storage system 140 are communicatively connected to the data processing system 110.

The data processing system 110 includes one or more data processing devices that implement the processes of the various embodiments of the present invention, including the example processes described herein. The phrases “data processing device” or “data processor” are intended to include any data processing device, such as a central processing unit (“CPU”), a desktop computer, a laptop computer, a mainframe computer, a personal digital assistant, a Blackberry™, a digital camera, cellular phone, or any other device for processing data, managing data, or handling data, whether implemented with electrical, magnetic, optical, biological components, or otherwise.

The data storage system 140 includes one or more processor-accessible memories configured to store information, including the information needed to execute the processes of the various embodiments of the present invention, including the example processes described herein. The data storage system 140 may be a distributed processor-accessible memory system including multiple processor-accessible memories communicatively connected to the data processing system 110 via a plurality of computers or devices. On the other hand, the data storage system 140 need not be a distributed processor-accessible memory system and, consequently, may include one or more processor-accessible memories located within a single data processor or device.

The phrase “processor-accessible memory” is intended to include any processor-accessible data storage device, whether volatile or nonvolatile, electronic, magnetic, optical, or otherwise, including but not limited to, registers, floppy disks, hard disks, Compact Discs, DVDs, flash memories, ROMs, and RAMs.

The phrase “communicatively connected” is intended to include any type of connection, whether wired or wireless, between devices, data processors, or programs in which data may be communicated. The phrase “communicatively connected” is intended to include a connection between devices or programs within a single data processor, a connection between devices or programs located in different data processors, and a connection between devices not located in data processors at all. In this regard, although the data storage system 140 is shown separately from the data processing system 110, one skilled in the art will appreciate that the data storage system 140 may be stored completely or partially within the data processing system 110. Further in this regard, although the peripheral system 120 and the user interface system 130 are shown separately from the data processing system 110, one skilled in the art will appreciate that one or both of such systems may be stored completely or partially within the data processing system 110.

The peripheral system 120 may include one or more devices configured to provide digital content records to the data processing system 110. For example, the peripheral system 120 may include digital still cameras, digital video cameras, cellular phones, or other data processors. The data processing system 110, upon receipt of digital content records from a device in the peripheral system 120, may store such digital content records in the data storage system 140.

The user interface system 130 may include a mouse, a keyboard, another computer, or any device or combination of devices from which data is input to the data processing system 110. In this regard, although the peripheral system 120 is shown separately from the user interface system 130, the peripheral system 120 may be included as part of the user interface system 130.

The user interface system 130 also may include a display device, a processor-accessible memory, or any device or combination of devices to which data is output by the data processing system 110. In this regard, if the user interface system 130 includes a processor-accessible memory, such memory may be part of the data storage system 140 even though the user interface system 130 and the data storage system 140 are shown separately in FIG. 1.

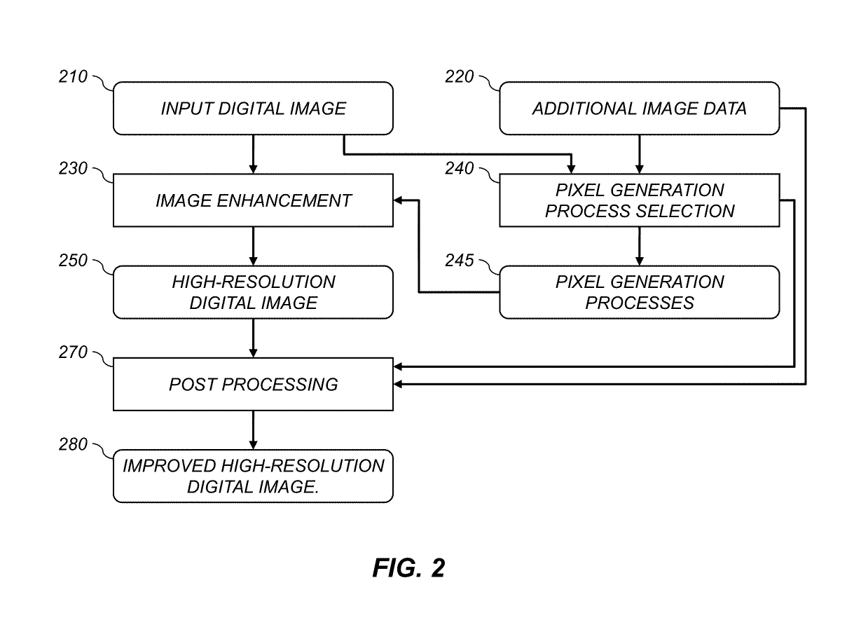

FIG. 2 is a flow chart of a high-level view of a method for single frame image super-resolution and enhancement in accordance with the present invention. Input digital image 210 and additional image data 220 are analyzed by a pixel generation process selection block 240 to select an appropriate pixel generation process 245 for each image pixel of the input digital image 210. Typically, the input digital image 210 will be a photographic image captured by a digital camera or digitized by a digital scanner. In some scenarios, the input digital image 210 is a low-resolution image that has been formed by resizing an original high-resolution image (e.g., for sending to another user as a text/E-mail, or for posting on the internet). In other cases, the input digital image 210 can be a composite document that includes some combination of text regions, graphics regions or photographic image regions.

The additional image data 220 can include various types of non-pixel information that pertains to the input digital image 210. In a preferred embodiment, the additional image data 220 includes metadata resided in the image file used to store the input digital image 210. For example, the metadata can include data pertaining to image capture settings such as image width and height, camera exposure index, exposure time, lens aperture (i.e., F/#), an indication of whether the flash was fired, and image compression settings. The metadata can also include an indication of various user-selectable options. For example, the user-selectable options can include information relevant to the formation of the improved high-resolution digital image 280 such as an output image size, display/printer characteristics, output media, and output finishing options. The metadata can also include semantic information pertaining to the image such as over-all scene type, regional content information and the location/identity of persons and objects. In some cases, some or all of the semantic information can be generated automatically by analyzing the input digital image 210 using any appropriate image analysis method known in the art. In other cases, some or all of the semantic information can be provided by a user using an appropriate user interface. For example the user can add a caption or manually identify persons to the input digital image 210.

An image enhancement block 230 operates on the input digital image 210 using the selected pixel generation models 245, thereby providing a high-resolution digital image 250. The high-resolution digital image 250 has an increased spatial resolution (i.e., a larger number of image pixels) and an improved image quality relative to the input digital image 210. Optionally, the high-resolution digital image 250 can be further enhanced in the post processing block 270 to provide the final improved high-resolution digital image 280. The post processing block 270 may operate responsive to various inputs including the additional image data 220 or data generated during the pixel generation process selection block 240.

After the improved high-resolution digital image 280 has been formed, it can be stored in some processor-accessible memory (e.g., in data storage system 140 (FIG. 1)) for use in any appropriate application. For example, the improved high-resolution digital image 280 can be displayed on a soft-copy display, printed on a digital printing system, or stored in an image database on a local storage device or on a network server for use at a later time.

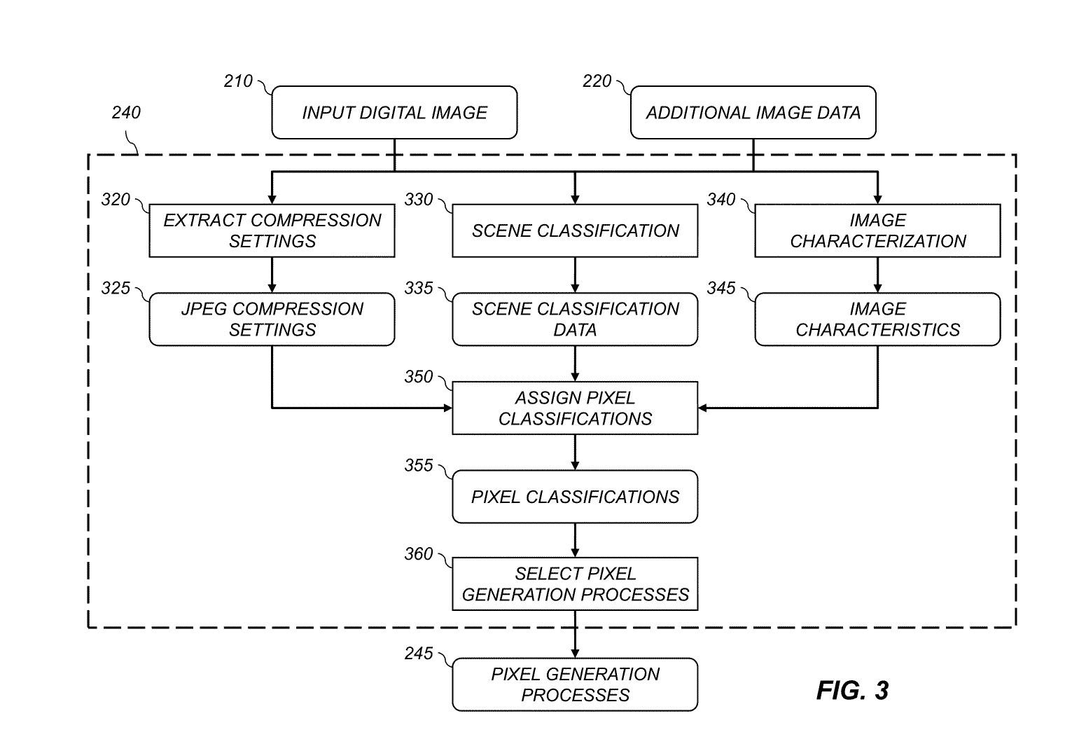

FIG. 3 is a flowchart showing additional details of the pixel generation process selection block 240 in FIG. 2 according to an embodiment of the present invention. An extract compression settings block 320 is used to extract JPEG compression settings 325 from the additional image data 220 (i.e., from the file header in the JPEG file) associated with the input digital image 210. Examples of JPEG compression settings 325 that can be extracted would include the JPEG compression table (e.g., the luminance quantization table Q[u,v] shown in Eq. (2)), or the JPEG quality factor Q_{f}. Since the compression artifacts in the input digital image 210 can vary significantly depending on the JPEG compression settings 325, knowledge of the JPEG compression settings 325 can be useful to select an appropriate pixel generation processes 245 that is optimized accordingly. In some embodiments, the JPEG quality factor Q_{f} may not be stored directly as metadata, but can be computed by the extract compression settings block 320 from the input digital image 210 and the additional image data 220 using methods well known to those skilled in the art.

Image regions within the input digital image 210 (or the entire input digital image 210) are classified using scene classification block 330 to associate each image region with one or more predefined classes. The resulting classifications are stored as classification data 335. The classes can include both global scene content classifications and local scene content classifications. Examples of classes that can be used in various embodiments would include Face Region; Text Region; Graphics Region, Indoor Scene, Outdoor Scene, Beach Scene, Portrait Scene and Macro Scene. The determination of the appropriate classes enables the selection of different pixel generation processes 245 for different types of image content. For example, the pixel generation process 245 that produces the best results for a text document may not produce the best results for a pictorial image of a person's face.

In some embodiments, the scene classification block 330 determines the classification data 335 by automatically analyzing one or both of the input digital image 210 and the additional image data 220. Algorithms for performing scene classification are well known in the art, and any appropriate algorithm can be used in accordance with the present invention. In some embodiments, a user interface providing various user-selectable options can be provided to enable a user to manually assign one or more classes to the input digital image 210 (or to regions in the input digital image 210).

An image characterization block 340 is used to analyze the image pixels in the input digital image 210 to determine image characteristics 345. The image characteristics 345 can include both global image characteristics and local image characteristics. Examples of image characteristics 345 that can be determined in various embodiments would include image size, edge activity, noise characteristics, and tone scale characteristics.

The image size characteristics of the input digital image 210, together with the desired output image size, provide an indication of the magnification that needs to be applied to the input digital image 210. The size of the input digital image 210 is typically stored as metadata in association with the image file (i.e., as part of the additional image data 220), and the output image size is typically provided by a user or specified in accordance with a particular application. In some embodiments, the total number of image pixels in the input digital image 210 can be used to represent the image size characteristics. In other embodiments, the image width or the image height or both can be used to represent time image size characteristics.

The edge activity image characteristic provides an indication of the local image structure at each pixel location. Various types of edge detection processes can be used to determine the edge activity. In some embodiments, the edge activity is determined by computing the magnitude of the intensity gradient. The edge activity can then be quantized into 3 ranges: low, median and high.

The noise activity image characteristic provides an indication of the noise (i.e., unwanted random variations) in the input digital image 210. The noise activity can be determined using various types of noise estimation processes as is known in the art. In some embodiments, the noise activity can be determined by computing a standard deviation of the pixel values in a flat image area. In other embodiments, the noise activity can be determined based on the additional image data 220 (e.g., images captured at higher exposure index settings are known to exhibit higher noise levels than images captured at lower exposure index settings). In some embodiments different noise activity levels can be determined for different image regions or different image pixels (e.g., the noise activity may be larger for dark image pixels than for light image pixels).

The tone scale activity provides an indication of the tone scale characteristics of the input digital image. The tone scale activity can be determined using various types of tone scale characterization methods. In some embodiments the tone scale activity provides an indication of image contrast, and can be measured from a histogram of the luminance values in the input digital image 210. For example, the tone scale activity can be determined by computing a difference between a minimum luminance code value (e.g., a code value which 99% of all image pixels in the input digital image 210 are greater than) and a maximum luminance code value (e.g., a code value which 99% of pixels in the input digital image 210 are less than). In some embodiments, a single tone scale activity value can be determined for the entire input digital image 210. In other embodiments, different tone scale activity values can be determined for different image regions, or on a pixel-by-pixel basis based on the image pixels in a local pixel neighborhood.

An assign pixel classifications block 350 is used to assign pixel classifications 355 to each image pixel in the input digital image 210 responsive to some or all of the JPEG compression settings 325, the scene classification data 335 and the image characteristics 345. In some cases, the same pixel classification 355 can be assigned to every image pixel in the input digital image 210. In other cases, different pixel classifications 355 can be assigned to different image pixels.

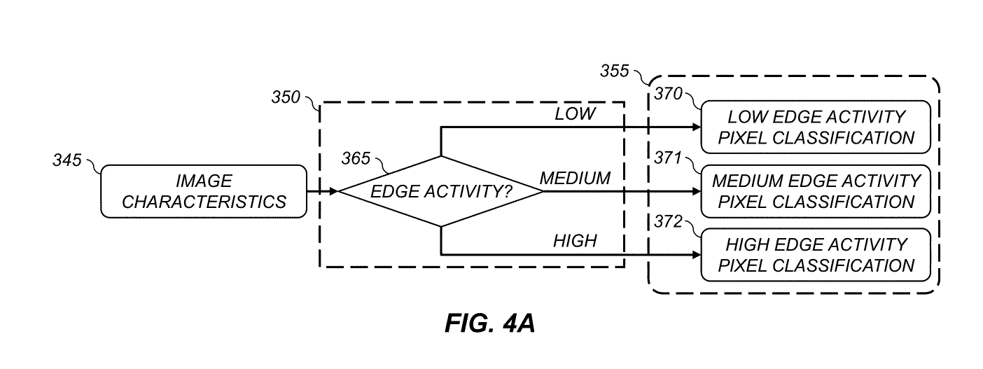

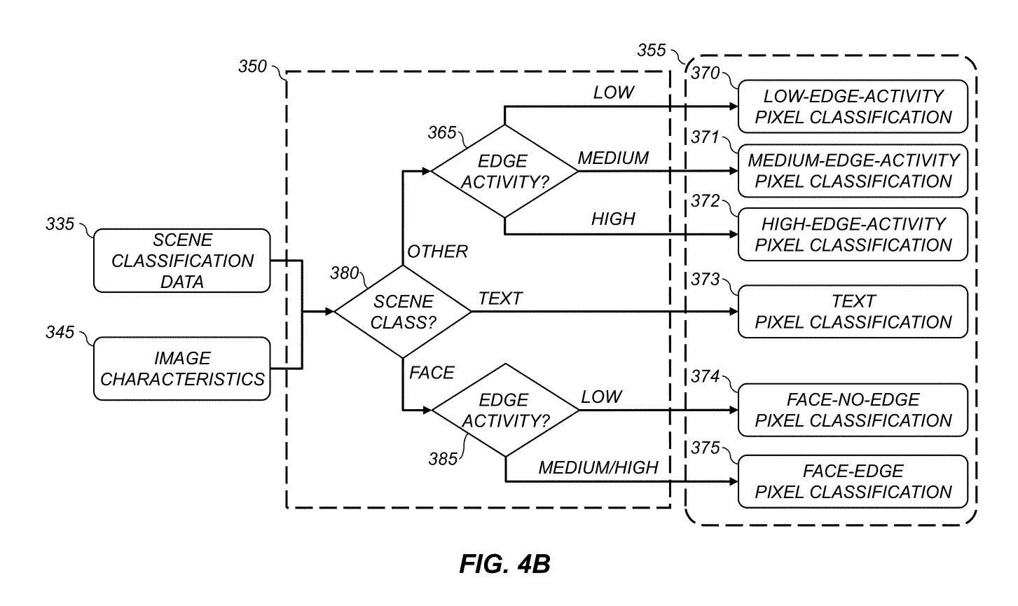

The pixel classifications 355 can be assigned using different strategies. For example, in some embodiments, the pixel classifications 355 can be assigned solely based on a single attribute (e.g., the edge activity level) as illustrated in FIG. 4A. In this case the assign pixel classifications block 350 applies an edge activity test 365 to the edge activity level determined in the image characteristics 345. If the edge activity level determined for an image pixel is “Low,” then the image pixel is assigned to a Low-Edge-Activity pixel classification 370. Similarly, if the edge activity level determined for an image pixel is “Medium,” then the image pixel is assigned to a Medium-Edge-Activity pixel classification 371, and if the edge activity level determined for an image pixel is “High,” then the image pixel is assigned to a High-Edge-Activity pixel classification 372.

In other embodiments, a more complex logic tree can be used to sequentially consider a set of different attributes as shown in FIG. 4B. In this example, the pixel classifications 355 are assigned based on the scene classification data 335 and the edge activity level. A scene classification test 380 examines the assigned scene classification. If the scene classification is “Text Region” a Text pixel classification 373 is assigned. If the scene classification is “Face Region” then an edge activity test 385 examines the edge activity level. If the edge activity level is “Low,” then the image pixel is assigned to a Face-No-Edge pixel classification 374, and if the edge activity level determined for an image pixel is “Medium” or “High” then the image pixel is assigned to a Face-Edge pixel classification 375. For other scene classifications, an edge activity test 365 is used to assign the pixel classification 355 as in FIG. 4A.

Depending on the strategy used by the assign pixel classifications block 350, it will be recognized that it is only necessary to compute the image attributes that are relevant to that strategy. For example, in some embodiments the assign pixel classifications block 350 can base the assignment of the pixel classifications solely on an edge activity characteristic as in FIG. 4A. In this case, it would not be necessary to extract the JPEG compression settings 325 or to determine any scene classification data 335.

A select pixel generation processes step 360 is used to select appropriate pixel generation processes 245 to be used for each of the image pixels in the input digital image 210 in accordance with the corresponding pixel classifications 355. In a preferred embodiment, the pixel generation process 245 associated with a particular pixel classification 255 is adapted to produce optimal results for the corresponding type of image content.

Various types of pixel generation processes 245 can be used in accordance with the present invention, including pixel interpolation algorithms and machine learning algorithms. Examples of appropriate pixel interpolation algorithms include, but are not limited to, nearest neighbor interpolation, bilinear interpolation and bicubic interpolation. These types of interpolation algorithms are well-known to those skilled in the image resizing art. Examples of appropriate machine learning algorithms include, but are not limited to, artificial neural networks, sparse representations, regression trees, Bayesian networks, support vector machines, and various combinations thereof. These types of machine learning algorithms are well-known to those skilled in the image processing art.

In some embodiments, different pixel generation processes 245 can be selected to operate on different color channels of the input digital image 210. For example, if the input digital image 210 is in a luma-chroma color space, such as the well-known YCᵣC_{b} color space, then it can be desirable to assign one pixel generation process to the luma color channel (i.e., “Y”) and a different pixel generation process to the chroma color channels (i.e., Cᵣ and C_{b}). In some embodiments, different pixel generation processes 245 can be selected to operate on different frequency bands of the input digital image 210.

In one exemplary embodiment, the image pixels in the input digital image are assigned to one of three different pixel classifications 355 corresponding to different edge activity levels as shown in FIG. 4A. For image pixels classified in the Low-Edge-Activity pixel classification 370, the select pixel generation processes block 360 selects a bicubic interpolation process for both the luma and chroma color channels. For image pixels classified in the Medium-Edge-Activity pixel classification 371 and the High-Edge-Activity pixel classification 372, a bicubic interpolation process is selected for the chroma color channels and neural network machine learning algorithms are selected for the luma channel. The neural network machine learning algorithm selected for the Medium-Edge-Activity pixel classification 371 is pre-trained using pixels in a set of training images having a medium edge activity level. Likewise, the neural network machine learning algorithm selected for the High-Edge-Activity pixel classification 372 is pre-trained using pixels in a set of training images having a high edge activity level.

In some embodiments, the pixel classification can be assigned according to multiple image attributes as illustrated in FIG. 4B. In this case, neural network machine learning algorithms can be selected that are trained under the same conditions (i.e., the scene classification and the same edge activity level). Likewise, machine learning algorithms can be trained for pixel classifications 355 classified according to other image attributes such as JPEG compression tables, JPEG quality factor, noise activity level or different tone scale activity level. In each case, the machine learning algorithms are preferably trained using training images having the same characteristics.

Returning to a discussion of FIG. 2, the image enhancement block is used to apply the selected pixel generation processes 245 to the input pixels in the input digital image 210 to determine the high-resolution digital image 250. In a preferred embodiment, each image pixel in the input digital image 210 is mapped to a corresponding block of high-resolution image pixels (e.g., a 2×2 block of image pixels) in the in the high-resolution digital image 250. In general, a neighborhood of image pixels around a particular image pixel are used by the pixel generation process 245 to determine the block of high-resolution image pixels. Depending on the form of the pixel generation processes 245, different size pixel neighborhoods will be needed for the computation of the high-resolution image pixels.

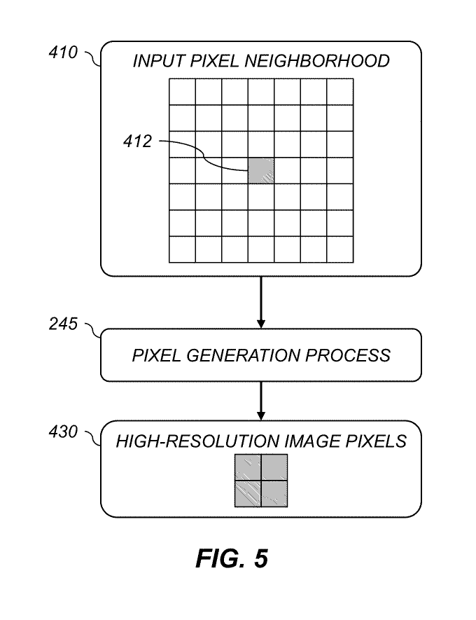

FIG. 5 is a schematic diagram showing how a pixel generation process 245 can be used to increase the image resolution by a factor of two in accordance with the present invention. A particular input pixel 412 is being processed in an input pixel neighborhood 410 of the input digital image 210 (FIG. 2). In this example, the pixel generation process 245 selected by the pixel generation process selection block 240 (FIG. 2) in accordance with the pixel classification 355 (FIG. 3) of the input pixel 412 is a neural network machine learning algorithm. The neural network machine learning algorithm has 49 input nodes (corresponding to the 7×7 block of input pixels centered on the input pixel 412 in the input pixel neighborhood 410) and 4 output nodes. The output nodes are the pixel values for a corresponding 2×2 block of high-resolution image pixels 430 in the high-resolution digital image 250 (FIG. 2). The neural network machine learning algorithm is preferably trained using training images having the same pixel classification 355 as the input pixel 412. This process is repeated for each input pixel 412 in the input digital image 210 (FIG. 2), thereby producing a high-resolution digital image 250 (FIG. 2) that is double the size of the input digital image 210.

It will be recognized by one skilled in the art that the size of the input pixel neighborhood 410 and the block-size for the high-resolution image pixels 430 can be different in various embodiments. For example, the neural network machine learning algorithm can be trained to operate using a different number of input nodes (e.g., a 5×5 block of image pixels or a 9×9 block of image pixels). Likewise, the neural network machine learning algorithm can be trained to provide a different number of high-resolution image pixels 430 (e.g., a 3×3 block of high-resolution image pixels 430).

The size of the input pixel neighborhood 410 will also depend on the type of pixel generation process 245. For example, different types of pixel interpolation algorithms can require different size input pixel neighborhoods 410 (e.g., a single input pixel can be used for nearest neighbor interpolation, a 2×2 block of input pixels can be used for bilinear interpolation, and a 4×4 block of input pixels can be used for bicubic interpolation).

In the embodiment illustrated in FIG. 5, the image resolution is increased by a factor of 2× so that each input pixel 412 is processed to provide a 2×2 block of high-resolution image pixels 430. In many cases, it may be desirable to change the resolution by a different factor. In some embodiments, the method of the present invention can be used to increase the resolution by a factor of 2×, then conventional image resizing algorithm can then be used to resize the image to the desired final resolution.

In other embodiments, the method of the present invention can be performed multiple times to increase the image resolution to the closest power of two to the desired final image resolution. A conventional image resizing algorithm can then be used to resize the image to the desired final resolution. For example, if it is desired to increase the resolution by a factor of 3.5×, the method of the present invention can be applied twice to provide a high-resolution image having a resolution increase of 4×. The resulting image can then be down-sampled using a conventional bicubic interpolation to obtain the desired output image resolution. When the method of the present invention is applied multiple times to a given input digital image 210, it may be desirable to train the pixel generation processes 245 differently for the first iteration and any additional iterations. For example, the pixel generation processes 245 used for the first iteration can be optimized to compensate for the compression artifacts in the input digital image 210, while the pixel generation processes 245 used for the additional iterations can be optimized to operate on digital images without such artifacts.

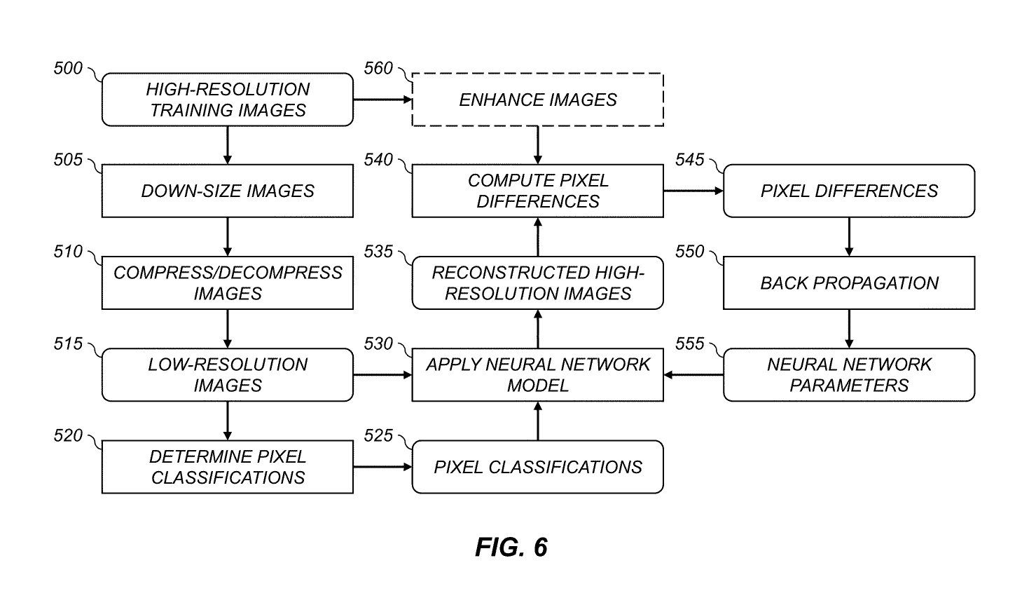

FIG. 6 is a block diagram showing an exemplary training process that can be used to train a neural network machine learning algorithm for use as a pixel generation process 245 (FIG. 2) for image pixels having a particular pixel classification 355 (FIG. 3) according to a preferred embodiment of the present invention. In this example, the neural network machine learning algorithm is adapted to increase the image resolution by a factor of 2×, while also enhancing the image to compensate for JPEG compression artifacts. A set of high-resolution training images 500 are used that contain image pixels having the particular pixel classification 255.

A down-size images step 505 is used to reduce size of high-resolution training images 500 by a factor of 2×. A compress/decompress images step 510 is used to apply a JPEG compression operation to the down-sized images, followed by a decompression operation, thereby providing low resolution images 515. A determine pixel classifications step 520 is used to determine pixel classifications 525 for the image pixels in the low-resolution images 515. The determine pixel classifications step 520 uses a process analogous to that described in FIG. 3 to determine the pixel classifications 525 responsive to appropriate image attributes.

An apply neural network model step 530 is used to process the low-resolution images 515 to determine reconstructed high-resolution images 535 responsive to a set of neural network parameters 555. The neural network parameters 555 correspond to the weighting parameters for the interconnections in the neural network, and are initialized to nominal values at the start of the training process. (The apply neural network model step 530 only needs to process the image pixels in the low-resolution images 515 that have the particular pixel classification 525 for which the neural network model is being trained.)

A compute pixel differences step 540 is used to compute pixel differences 545 between the image pixels in the high-resolution training image 500 and the corresponding image pixels in the reconstructed high-resolution images 535. (The pixel differences 545 only need to be determined for image pixels that have the particular pixel classification 525 for which the neural network model is being trained.)

A back propagation training process is used to determine the neural network parameters 555 that minimize the pixel differences 545 for the training set. The following description is a high-level summary of an exemplary back propagation training process; the details of such processes will be well-known to one skilled in the art. A back propagation step 550 is used to update the neural network parameters 555 responsive to the pixel differences 545. The updated neural network parameters 555 are then used to determine an updated set of reconstructed high-resolution images 535 and an updated set of pixel differences 545. This process is repeated iteratively until the set of neural network parameters 555 that minimize the pixel differences 545 are identified.

The neural network training process shown in FIG. 6 is performed for each of the different pixel classifications for which a neural network pixel generation process is to be used.

In some embodiments, other operations can be used to modify the down-sized training images in addition to the compress/decompress images step 510 in FIG. 6. For example, various image modifications can be performed to simulate the addition of noise or camera filter array artifacts in a digital camera system, or to add simulated dust, scratch, and other scanner artifacts. Doing so, will additionally train the neural network model to compensate for such artifacts.

In addition to removing unwanted artifacts, the machine learning training process in FIG. 6 can also be modified to introduce desired effects or looks. For example, face or skin regions can be detected in the down-sized images and simulated skin blemishes can be added. In this way, the neural network model can be trained to provide automatic blemish removal as part of the pixel generation process 245.

In some embodiments, the high-resolution training images 500 can be modified using an optional enhance images step 560 after the formation of the low-resolution images 515 to introduce various image enhancements. In some embodiments, the image enhancements can include image processing operations such as image sharpening or noise removal. The image enhancements can also include applying artistic variations such as water color, line sketch, cartoonization, and other artistic effects. The neural network model can then be trained to automatically provide reconstructed high-resolution images 535 that are similar to the modified high-resolution training images, and will therefore include these special effects.

In some embodiments, the neural network model can be trained to generate intermediate data for up-stream processing. For example, in some applications, the high-resolution training images 500 can be images of product on an assembly line or medical diagnostic scans of blood samples. The enhance images step 560 can be used to manually or automatically modify the high-resolution training images 500 in a way that facilitates identification of manufacturing defects or cell malignancies, respectively. In this way, the neural network model can then be trained to automatically provide reconstructed high-resolution images 535 where the manufacturing defects or cell malignancies are similarly highlighted. It will be readily obvious to those skilled in the art that this approach can readily be extended to various type of image enhancement applications in the manufacturing, security, military, and consumer fields.

As mentioned earlier, other types of machine learning algorithms can also be used for pixel generation processes in various embodiments of the present invention (e.g. sparse representations, regression trees, Bayesian networks, or Support Vector Machines). Those skilled in the art will recognize that appropriate training processes can be used to train the machine learning algorithms accordingly. Pixel interpolation algorithms do not generally require a training process.

The type of pixel generation process 245 that is used for each pixel classification 355 can be determined in various ways. In some cases, a variety of different pixel generation processes 245 (e.g., different pixel interpolation algorithms and different machine learning algorithms) can be applied to a set of training images and optimized accordingly. The pixel generation process 245 that produces the best results (e.g., the lowest average pixel difference 545) can then be selected. In some cases, there will be significant differences in the computational complexity of the different pixel generation processes 245. Therefore, it some cases it may be appropriate to make a tradeoff between the quality of the results and the computational efficiency.

In some embodiments, the determination of the high-resolution image pixels 430 (FIG. 5) by the pixel generation process 245 is further responsive to metadata associated with the input digital image 210 (FIG. 2). One convenient mechanism to accomplish this is to add additional input nodes to the machine learning algorithm. In the embodiment that was discussed relative to FIG. 5, the neural network machine learning algorithm had 49 input nodes, corresponding to the 7×7 block of image pixels in the input pixel neighborhood 410. In some embodiments, one or more additional input nodes can be added corresponding to metadata (additional image data 220) associated with the input digital image 210. In some cases a metadata field in the additional image data 220 (FIG. 2) can be used directly as the parameter which is fed into the input node, Alternatively, the parameter fed into the input node can be determined by performing one or more analysis steps based on the additional image data 220, or image pixels in the input digital image 210. Examples of parameters that would be appropriate for use as input nodes would be the JPEG quality factor or the image magnification factor.

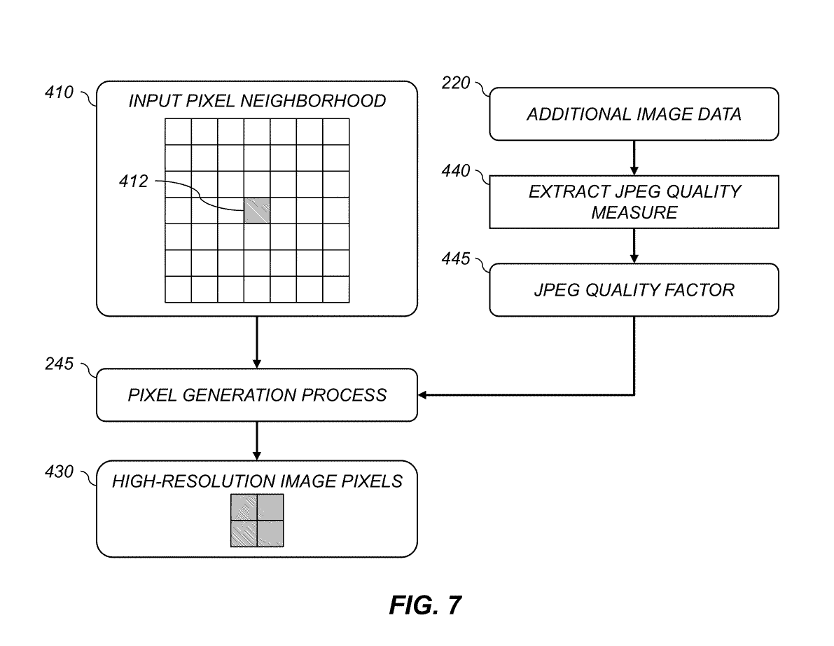

FIG. 7 is a schematic diagram illustrating an embodiment where the JPEG quality factor 445 is used as an input node for the neural network machine learning algorithm. An extract JPEG quality factor step 440 is used to extract the JPEG quality factor 445 from the additional image data 220 associated with the input digital image 210 (FIG. 2). In this case, the neural network machine learning algorithm used for the pixel generation process 245 has 50 input nodes corresponding to the 49 pixels in the input pixel neighborhood 410, together with the JPEG quality factor 445.

As will be well-known to one skilled in the compression art, the JPEG quality factor 445 (Q_{f}) is a number that is used to scale the standard JPEG T50 quantization table, which was given in Eq. (2). The value of Q_{f} can range from 1 to 100, and is used to compute a scale factor S:

$$S = \{ \begin{matrix}5000 / {Q}_{f} & {Q}_{f} < 50 \\ 200 - 2 {Q}_{f} & {Q}_{f} > 50\end{matrix} \qquad ( 3 )$$

The scale factor is then used to scale the T50 quantization table to provide the quantization table Q[u,v] to be used by the JPEG compression algorithm:

Q[u,v]=S*T50[u,v] (4)

Large values of the JPEG quality factor 445 (e.g., Q_{f}>90) will result in negligible losses in image quality, while small values of the JPEG quality factor 445 (e.g., Q_{f}<25) will result in significant losses in image quality.

The neural network machine learning algorithm used for the pixel generation process 245 of FIG. 7 can be trained using a process similar to that shown in FIG. 6, except that the compress/decompress images step 510 compresses the down-sized images with a variety of different JPEG quality factors 445. The JPEG quality factors are then used as an additional input to apply neural network model step 530. Preferably, each high-resolution training image 500 is compressed using a set of different JPEG quality factors 445 which span the range of quality levels that will be commonly encountered.

In some embodiments, the determination of the high-resolution image pixels 430 (FIG. 5) by the pixel generation process 245 is further responsive to the location of the input pixel within the input digital image 210 (FIG. 2). For example, JPEG compression algorithms are known to produce block artifacts where visible contours appear at the edges of the 8×8 pixel JPEG blocks, particularly when low JPEG quality factors are used. The relative position of the input pixel 412 within the JPEG block can provide information that is useful for reducing such artifacts during the application of the pixel generation process. In some embodiments, a horizontal pixel position and a vertical pixel position are used as additional input nodes to the neural network machine learning algorithm, where both numbers are integers between 1 and 8, corresponding to the horizontal and vertical coordinates of the input pixel 412 within the 8×8 JPEG block.

As mentioned earlier, an optional post processing block 270 can be used to process the high-resolution digital image 250 to provide the final improved high-resolution digital image 280. The post processing block 270 can perform any type of image processing known in the art, such as additional resizing, tone/color processing, sharpening, halftoning noise removal or texture processing (e.g., noise addition or removal).

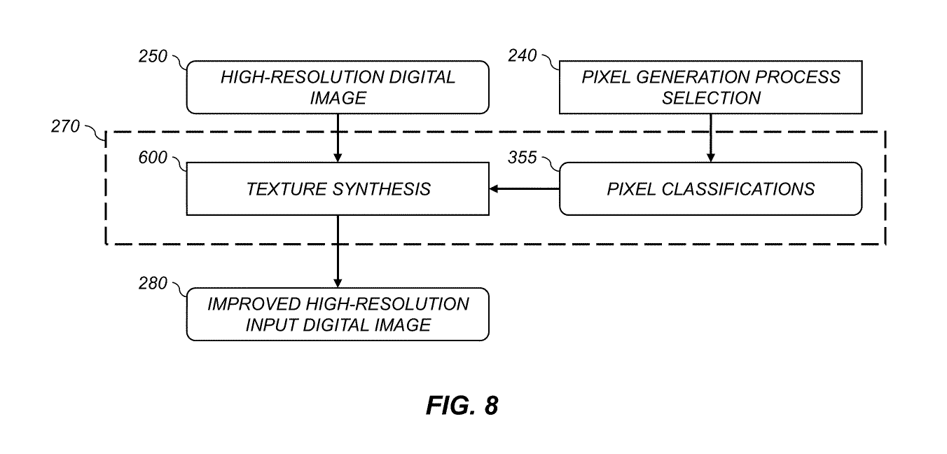

In an exemplary embodiment, the post processing block 270 applies a texture synthesis process 600 as illustrated in FIG. 8. Methods for synthesizing texture are well-known to those skilled in the art. In a preferred embodiment, the texture synthesis process 600 uses the method described by commonly-assigned U.S. Pat. No. 7,023,447 to Luo et al., entitled “Block sampling based method and apparatus for texture synthesis,” which is incorporated herein by reference.

It has been observed that in some cases, the high-resolution digital image 250 can have certain texture attributes that may appear unnatural to a human observer. For example, the texture in relatively flat facial regions (e.g., the cheeks and forehead regions) may be overly flat and cause the face to appear “plastic” and mannequin-like. In this case, the perceived image quality can be improved by adding an appropriate texture (i.e., spatially-varying “noise”) using the texture synthesis process 600. In a preferred embodiment, different texture characteristics are imparted by the texture synthesis process 600 responsive to the pixel classifications 355 (FIG. 3) assigned to the different image regions in the pixel generation process selection block 240. For example, a texture pattern corresponding to a low-amplitude spatial noise pattern having frequency characteristics typical of a skin region in a high-resolution face can be imparted for input pixels classified according to a Face-No-Edge pixel classification 374 (FIG. 4B), while no additional texture is imparted for input pixels classified according to a Face-Edge pixel classification 375 (FIG. 4B). Similarly, in some embodiments, some input pixels may be classified using a Green-Grass pixel classification. Such image regions have a tendency to be reproduced with an overly flat texture, causing it to appear more like a carpet. In this case, the texture synthesis process can impart an appropriate grass texture in corresponding image regions.

A computer program product can include one or more non-transitory, tangible, computer readable storage medium, for example; magnetic storage media such as magnetic disk (such as a floppy disk) or magnetic tape; optical storage media such as optical disk, optical tape, or machine readable bar code; solid-state electronic storage devices such as random access memory (RAM), or read-only memory (ROM); or any other physical device or media employed to store a computer program having instructions for controlling one or more computers to practice the method according to the present invention.

The invention has been described in detail with particular reference to certain preferred embodiments thereof, but it will be understood that variations and modifications can be effected within the spirit and scope of the invention.

### PARTS LIST

110 data processing system
120 peripheral system
130 user interface system
140 data storage system
210 input digital image
220 additional image data
230 image enhancement block
240 pixel generation process selection block
245 pixel generation processes
250 high-resolution digital image
270 post processing block
280 improved high-resolution digital image.
320 extract compression settings block
325 JPEG compression settings
330 scene classification block
335 scene classification data
340 image characterization block
345 image characteristics
350 assign pixel classifications block
355 pixel classifications
360 select pixel generation processes block
365 edge activity test
370 Low-Edge-Activity pixel classification
371 Medium-Edge-Activity pixel classification
372 High-Edge-Activity pixel classification
373 Text pixel classification
374 Face-No-Edge pixel classification
375 Face-Edge pixel classification
380 scene classification test
385 edge activity test
410 input pixel neighborhood
412 input pixel
430 high resolution image pixels
440 extract JPEG quality factor step
445 JPEG quality factor
500 high-resolution training images
505 down-size images step
510 compress/decompress images step
515 low-resolution images
520 determine pixel classifications step
525 pixel classifications
530 apply neural network model step
535 reconstructed high-resolution images
540 compute pixel differences step
545 pixel differences
550 back propagation step
555 neural network parameters
560 enhance images
600 texture synthesis process

1. A method for processing an input digital image having a number of input image pixels to determine an output digital image having a larger number of output image pixels, comprising:
analyzing the image pixels in the input digital image to assign each image pixel to one of a plurality of different pixel classifications;
providing a plurality of pixel generation processes, each pixel generation process being associated with a different pixel classification and being adapted to operate on a neighborhood of input image pixels around a particular input image pixel to provide a plurality of output image pixels corresponding to the particular input image pixel;
for each input image pixel:
selecting the pixel generation process corresponding to the pixel classification associated with the input image pixel; and
operating on a neighborhood of input image pixels around the input image pixel using the selected pixel generation process to provide a plurality of output image pixels for the output digital image; and
storing the output digital image in a processor accessible memory;
wherein the method being performed, at least in part, by a data processor.

2. The method of claim 1 wherein the assignment of the pixel classification is responsive to metadata associated with the input digital image.

3. The method of claim 1 wherein the analysis of the input image pixels includes analyzing local image structure to determine an edge activity value for each input image pixel.

4. The method of claim 1 wherein the analysis of the input image pixels includes analyzing local image structure to determine a noise energy value for each input image pixel.

5. The method of claim 1 wherein the analysis of the input image pixels includes determining a local scene content classification or a global scene content classification.

6. The method of claim 1 wherein the assignment of the pixel classification is responsive to a user-selectable option.

7. The method of claim 1 wherein the determination of the output image pixels by the pixel generation processes is further responsive to one or more parameters determined from metadata associated with the input digital image.

8. The method of claim 1 wherein the determination of the output image pixels by the pixel generation processes is further responsive to one or more parameters determined by analyzing the image pixels in the input digital image.

9. The method of claim 1 wherein the determination of the output image pixels by the pixel generation processes is further responsive to a location of the input image pixel within the input digital image.

10. The method of claim 1 wherein at least some of the pixel generation processes are machine learning algorithms.

11. The method of claim 10 wherein at least some of the machine learning algorithms are neural network algorithms.

12. The method of claim 10 wherein the machine learning algorithm is trained to provide an enhanced output digital image incorporating one or more image enhancements.

13. The method of claim 1 wherein at least some of the pixel generation processes are pixel interpolation algorithms.

14. The method of claim 13 wherein at least some of the pixel interpolation algorithms are bicubic interpolation algorithms or bilinear interpolation algorithms.

15. The method of claim 1 further including applying one or more post processing operations to modify the output digital image.

16. The method of claim 15 wherein the post processing operations include a texture synthesis operation that imparts texture characteristics to the output digital image responsive to the pixel classification.
